(19) United States
(12) Patent Application Publication
(10) Pub. No.: US 2007/0101329 A1
(43) Pub. Date: May 3, 2007

(54) Workflow verification system and method thereof

(76) Inventor: Arthur Chen, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/450,309

(22) Filed: Jun. 12, 2006

(30) Foreign Application Priority Data
Nov. 3, 2005 (TW) 094138623

(51) Int. Cl. G06F 9/46

(52) U.S. Cl. 718/100

(57) ABSTRACT

A workflow verification system and a method are provided. A weight factor of a first workflow node, weight factors of a plurality of workflow nodes, and a weight factor of a second workflow node are calculated from a workflow to compare the weight factor of the first workflow node, the weight factors of the plurality of workflow nodes, the weight factor of the second workflow node. Afterward, the weight factor of the second workflow node is verified to equal the weight factor of the first workflow node in order to confirm the validity and the accuracy for the workflow. By the way mentioned above, the workflow can be checked beforehand to avoid to implement an error workflow caused by a careless mistake in the future.

### FIELD OF THE INVENTION

The present invention relates to a workflow verification system and method thereof, and more particularly, to a workflow verification system and method for verifying the validity and the accuracy of a workflow by providing a correspondence weight factor.

### BACKGROUND OF THE INVENTION

To understand a project with a rate of progress, a workflow which connects all working procedures is usually designed on actual demands to record and control the project with the progress rate at real time by verifying each node of the workflow and entire workflows can also be traced to provide references for improvements, since projects developed.

A workflow includes a serial routing and a parallel routing. FIG. 1 is a schematic diagram illustrating a conventional serial routing. As shown in FIG. 1, the workflow 1′ for verifying product development data comprises at least one serial routing 10′. The serial routing 10′ is used for transmitting the product development data to a workflow node for verifying every level of the workflow 1′. The product development data are verified by a first workflow node 12′ of the workflow 1′ at first. The product development data of the workflow 1′ is transmitted to a second workflow node 14′ of a next level after finishing verification. The product development data is further transmitted to a third workflow node 16′ of a next level to finish the entire procedure.

Additionally, FIG. 2A is a schematic diagram illustrating a conventional parallel routing. The parallel routing 20′ differs from the serial routing 10′. The product development data of the parallel routing 20′ is transmitted to at least two workflow nodes simultaneously while in a level of the workflow 1′. A workflow node of a next level must wait until the product development data are verified by the workflow nodes in order to implement the workflow. As shown in FIG. 2A, in a workflow 1′, the serial routing 10′ is to transmit the product development data to the first workflow node 12′ for verifying. Secondly, the parallel routing 20′ of the workflow 1′ is to transmit the product development data to a second workflow node 14′ and a third workflow node 16′ of a next level for verifying. Lastly, the product development data are then transmitted by the second workflow node 14′ and the third workflow node 16′ to a fourth workflow node 18′ of a next level for verifying in order to finish the entire procedure of verifying the product development data.

Although the workflow comprises the serial routing and the parallel routing, in real practice, the serial routing is in common use in the workflow due to management and verification. The serial routing means that the workflow node is used for verifying every level of the workflow without flexibility. Furthermore, to survey the current project implementation, the project implementation must cooperate with many departments simultaneously. Relatively, many workflow nodes are also used to correspond with the implementation of the project. Therefore, the parallel routing will be the future tendency in the workflow design.

However, the workflow planner may make a careless mistake while designing a workflow having a parallel routing. FIG. 2B is a schematic diagram illustrating a workflow for verifying product development data. After the product development data are verified by the first workflow node 12′, the product development data are then transmitted to the second workflow node 14′ and the third workflow node 16′ for verifying. Due to the careless mistake made by the workflow planner, the second workflow node 14′ is not connected to the fourth workflow node 18′. The consequence is that a verification action is implemented by the fourth workflow node 18′ after receiving verification documents from the third workflow node 16′. The second workflow node 14′ is then suspended in the workflow 1′ and the verification documents in the second workflow node 14′ are not transmitted to the fourth workflow node 18′. If a verification result verified by the second workflow node 14′ is to refuse the product development, the fourth workflow node 18′ is not planned to receive the verification documents verified by the second workflow node 14′ that the product which has been refused to develop is still concerned to develop and further causes implementation problems in the future. Therefore, a solution must be provided to overcome the drawbacks and disadvantages in order to verify the established workflow while planning the workflow having the parallel routing and thereby avoid the implementation problems in the future.

### SUMMARY OF THE INVENTION

Briefly, the present invention provides a workflow verification system and method that are applied for verifying a workflow having a parallel routing in order to provide a workflow planer to verify the accuracy for the workflow.

To achieve the object and the advantage of the mentioned above, the workflow verification system and its method are to verify the workflow. The workflow comprises a first workflow node, a second workflow node which is behind the first workflow node and a plurality of workflow nodes between the first workflow node and the second workflow node in order to calculate correspondence weight factors. A weight factor of the first workflow node is a sum of weight factors of the plurality of workflow nodes which is connected to the first workflow node and a weight factor of the second workflow node is the sum of the weight factors of the plurality of workflow nodes which is also connected to the second workflow node. Therefore, the weight factor of the first workflow node and the sum of the weight factors of the plurality of workflow nodes are compared whether they are the same. The weight factor of the second workflow node and the sum of the weight factors of the plurality of workflow nodes are compared whether they are the same. Lastly, the weight factor of the second workflow node and the weight factor of the first workflow node are verified whether they are equivalent. By the way mentioned above, the workflow planner may verify the workflow built by himself to avoid providing an error workflow while planning the workflow including the parallel routing. Furthermore, the workflow planner may plan the workflow having the parallel routing and a serial routing to design various workflows.

Other features and advantages of the present invention and variations thereof will become apparent from the following description, drawings, and claims.

### BRIEF DESCRIPTION OF THE DRAWINGS

FIG. 1 is a schematic of a conventional workflow having a serial routing;

FIG. 2A is a schematic diagram of a conventional workflow having a parallel routing;

FIG. 2B is a schematic diagram of a workflow with invalidity;

FIG. 3 is a flowchart according to a preferred embodiment of the present invention;

FIG. 4 is a schematic diagram of a workflow according to a preferred embodiment of the present invention;

FIG. 5 is a schematic diagram of a workflow with invalidity according to the present invention;

FIG. 6 is another schematic diagram of a workflow according to a preferred embodiment of the present invention;

FIG. 7 is a further schematic diagram of a workflow according to a preferred embodiment of the present invention; and

FIG. 8 is a block diagram according to a preferred embodiment of the present invention.

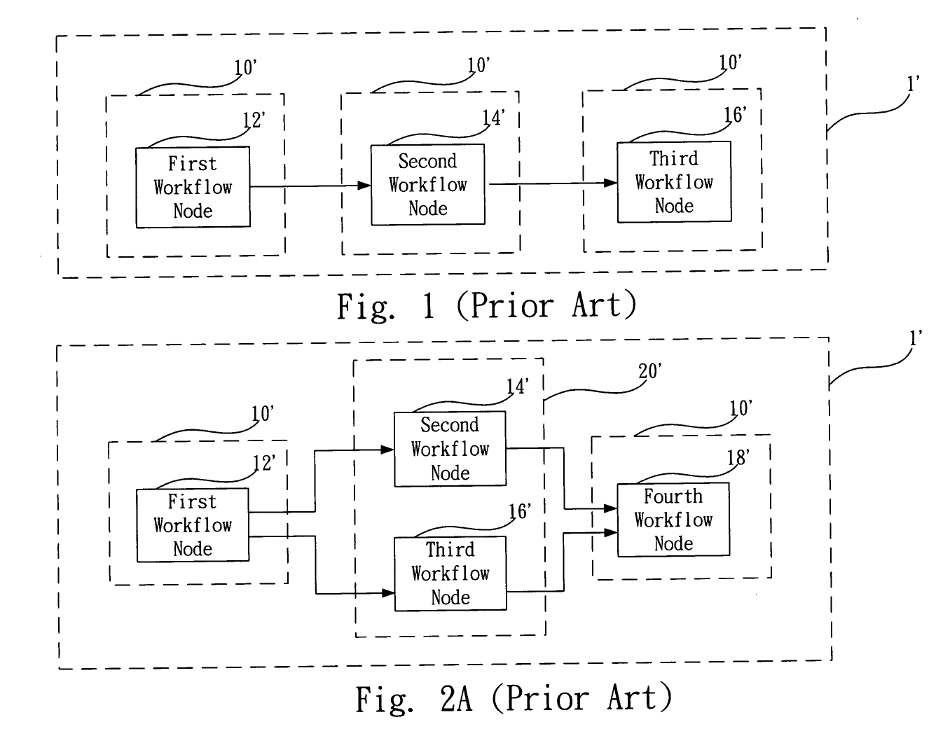

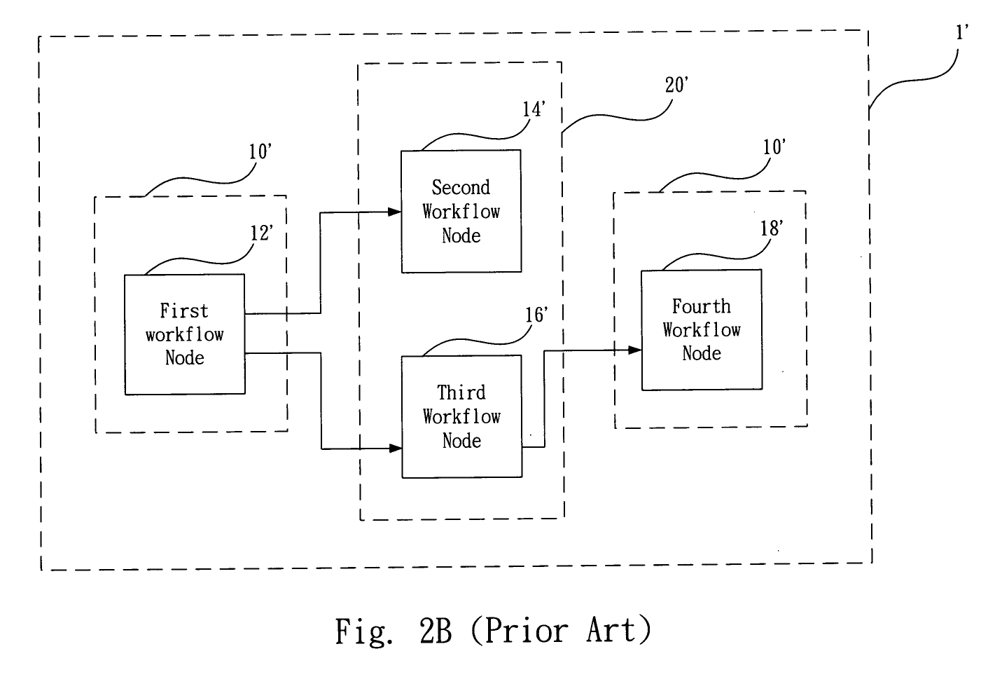

### DETAILED DESCRIPTION OF THE PREFERRED EMBODIMENTS

To avoid an error workflow caused by the careless mistake when a workflow planner designs a workflow, the present invention discloses a workflow verification system and a method to provide the workflow planner to verify the accuracy and the validity for the workflow.

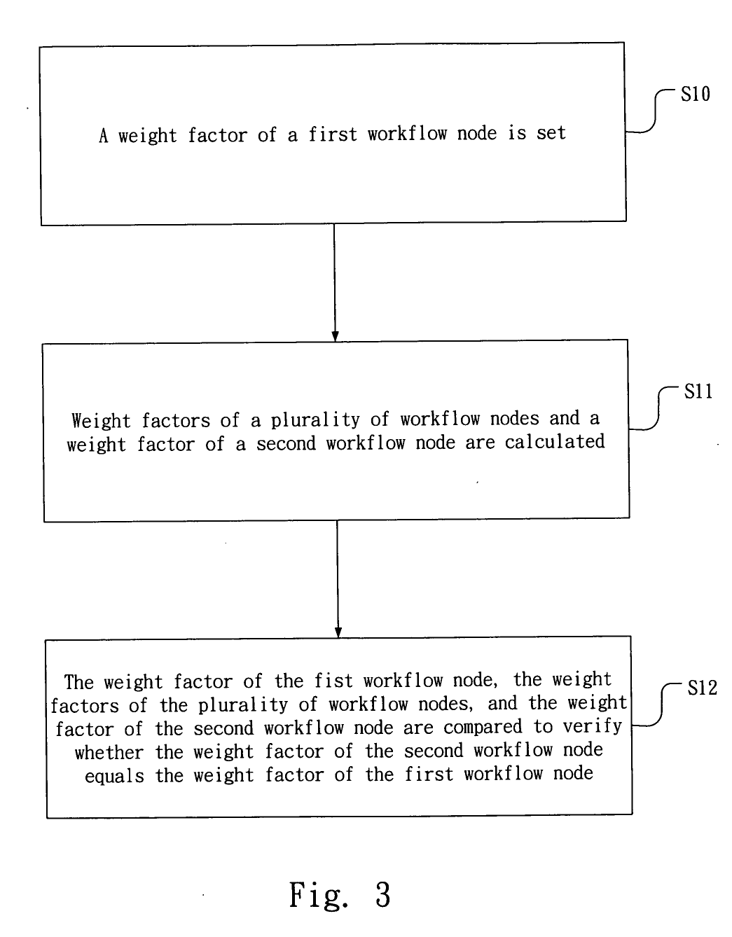

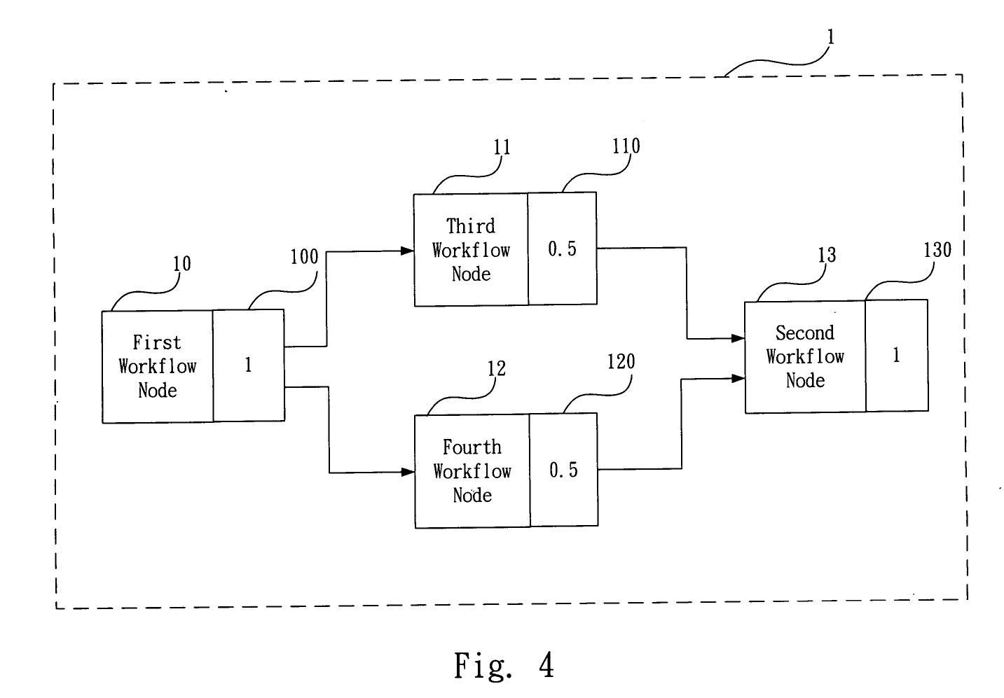

Referring to FIG. 3, a flowchart according to a preferred embodiment of the present invention is illustrated. The present invention is to verify a workflow. With reference to FIG. 4, the workflow 1 comprises a first workflow node 10, a plurality of workflow nodes (a third workflow node 11 and a fourth workflow node 14), and a second workflow node 13. The workflow 1 is described in sequence as following. Firstly, a procedure is implemented by the first workflow node 10. Secondly, the procedure is then transmitted to the third workflow node 11 which is connected to the first workflow node 10 and the fourth workflow node 12 which is connected to the first workflow node 10 respectively for verifying. Lastly, the procedure is then transmitted to the second workflow node 13 which is connected to both the third workflow node 11 and the fourth workflow node 12 for verifying and finishes the workflow 1. The first workflow node 10 can be an initial workflow node. The third workflow node 11 and the fourth workflow node 12 can be middle workflow nodes. The second workflow node 13 can be an end workflow node.

The method of the present invention comprises the following steps. Firstly, as shown in step S10, a first weight factor of the first workflow node 10 is set as 1. To implement step S11, the weight factor 100 of the first workflow node 10 of an upper level is equally allocated to a weight factor of the third workflow node 11 and a weight factor of the fourth workflow node 12 of a lower lever to calculate a second weight factor 130 of a second workflow node 13 which corresponds to the third workflow node 11 and the fourth workflow node 12. Suppose the third weight factor 110 and the fourth weight factor 120 are 0.5 respectively (1 (The first weight factor 100)÷2 (The third workflow node 11 and the fourth workflow node 12)=0.5 (The third weight factor 110 and the fourth weight factor 120)). In another word, because of the third workflow node 11 and the fourth workflow node 12 are connected to the first workflow node 10, the sum of the third weight factor 110 which corresponds to the third workflow node 11 (The lower level for the first workflow node 10) and the fourth weight factor 120 which corresponds to the fourth workflow node 12 (The lower level for the first workflow node 10) equals the first weight factor 100 of the first workflow node 10 (the upper level for the third workflow node 11 and the fourth workflow node 12). The third weight factor 110 and the fourth weight factor 120 are 0.5 respectively. On the other hand, the second workflow node 13 is connected to the third workflow node 11 and the fourth workflow node 12. The second weight factor 130 of the second workflow node 13 (The lower level for the third workflow node 11 and the fourth workflow node 12) equals the sum of the third weight factor of the third workflow node 11 and the fourth weight factor of the fourth workflow node 12 (The upper level for the second workflow node 13). The second weight factor 130 is 1.

Afterward, step S12 is implemented, the first weight factor of the first workflow node 10, the third weight factor of the third workflow node 11, the fourth weight factor of the fourth workflow node 12, and the second weight factor of the second workflow node 13 are compared. The second weight factor 130 of the second workflow node 13 is verified to equal the sum of the third weight factor 110 and the fourth weight factor 120. Because of the second workflow node 13 is behind the first workflow node 10 that also verifies if the second weight factor 130 equals the first weight factor 100. If the second weight factor 130 equals the first weight factor 100, the second workflow node 13 is obtained. Therefore, a verification outcome is generated to be a successful message. The workflow planner is further noticed that the workflow 1 is validity.

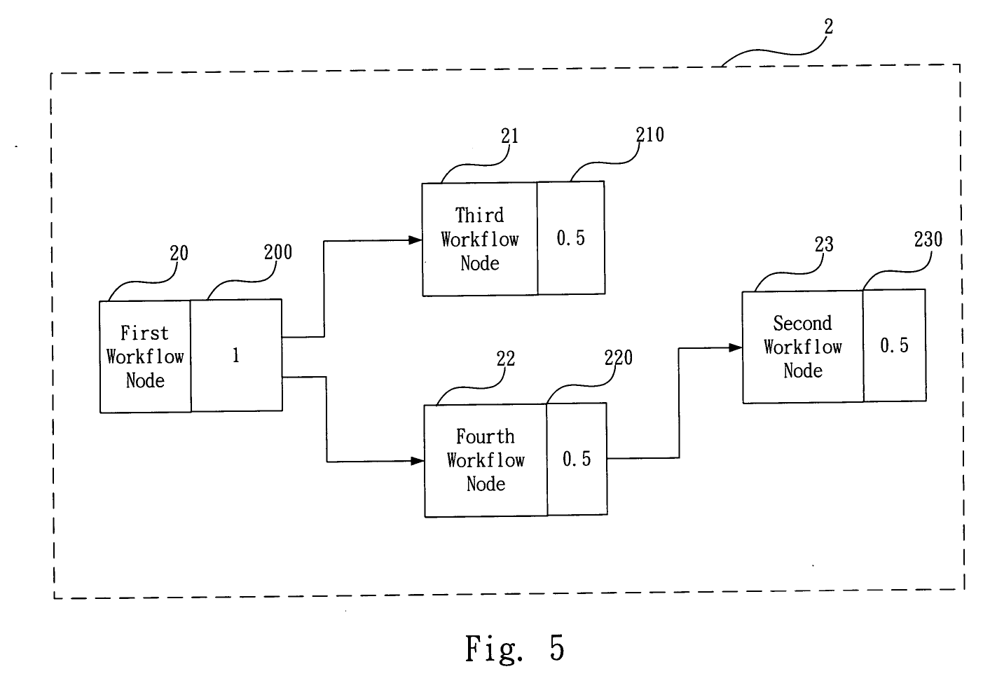

Referring to FIG. 5, a schematic diagram illustrates a workflow with invalidity. As shown in FIG. 5, a workflow 2 comprises a first workflow node 20, a plurality of workflow nodes (A third workflow node 21 and a fourth workflow node 22), and a second workflow node 23. In the workflow 2, the third workflow node 21 is not connected to the second workflow node 23 due to a careless mistake made by a workflow planner.

Referring back to FIG. 3, from step S10 to step S11, the first weight factor 200 of the first workflow node 20 is 1. The second weight factor 230 of the second workflow node 23 is 0.5. The third weight factor 210 of the third workflow node 21 is 0.5. The fourth weight factor 220 of the fourth workflow node 22 is 0.5. The third workflow node 21 is not connected to the second workflow node 23 due to the careless mistake made by the workflow planner.

The second weight factor 230 is an error weight factor. Therefore, the first weight factor of the first workflow node 20, the second weight factor of the second workflow node 23, the third weight factor of the third workflow node 21, and the fourth weight factor of the fourth workflow node 22 are compared via step S12 as shown in FIG. 3. The second weight factor 230 of the second workflow node 230 is verified to not equal the first weight factor 200 of the first workflow node 20. A verification outcome is generated to be a failure message. The workflow planner is further noticed that the workflow 2 is invalidity.

By the way mentioned above, the workflow node which is behind a foresaid workflow node is then given an error weight factor when an error workflow node exists in a workflow due to the careless mistake. Therefore, the present invention uses the characteristic by comparing with weight factors to verify the validity and the accuracy for a workflow.

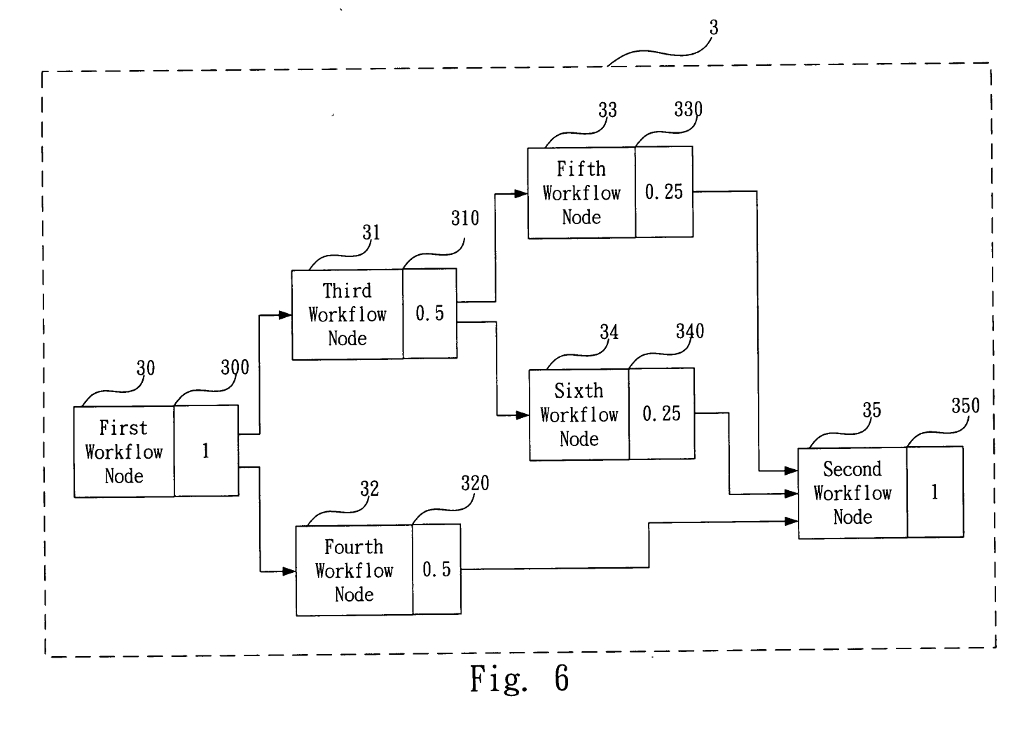

In addition, referring to FIG. 6, a workflow 3 comprises a first workflow node 30, a plurality of workflow nodes and a second workflow node 35. The plurality of workflow nodes are a third workflow node 31, a forth workflow node 32, a fifth workflow node 33 and a sixth workflow node 34. The first workflow node 30 is an upper level for the third workflow node 31 and the fourth workflow node 32. In other words, the third workflow node 31 and the fourth workflow node 32 are a lower level for the first workflow node 30. The third workflow node 31 is an upper level for the fifth workflow node 33 and the sixth workflow node 34. The fifth workflow node 33 and the sixth workflow node 34 are a lower level for the third workflow node 31. The fourth workflow node 32, the fifth workflow node 33 and the sixth workflow node 34 are an upper level for the second workflow node 35 and the second workflow node 35 is a lower level for the fourth workflow node 32, the fifth workflow node 33 and the sixth workflow node 34.

The workflow 3 is verified by the present invention as shown in FIG. 6, firstly, a first weight factor 300 is set to be 1, and the weight factor of each workflow node is then calculated. Secondly, the first weight factor 300 is verified to equal a sum of a third weight factor 310 and a fourth weight factor 320. The third weight factor 310 is verified to equal a sum of a fifth weight factor 330 and a sixth weight factor 340. The sum of the fourth weight factor 320, the fifth weight factor 330 and the sixth weight factor 340 is verified to equal a second weight factor 350. Lastly, the second weight factor 350 of the second workflow node 35 is verified to equal the first weight factor 300 of the first workflow node 30. In the embodiment, the first workflow node 30 is set to be an initial workflow node. The third workflow node 31, the fourth workflow node 32, the fifth workflow node 33 and the sixth workflow node 34 are set to be middle workflow nodes. The second workflow node 35 is set to be an end workflow node.

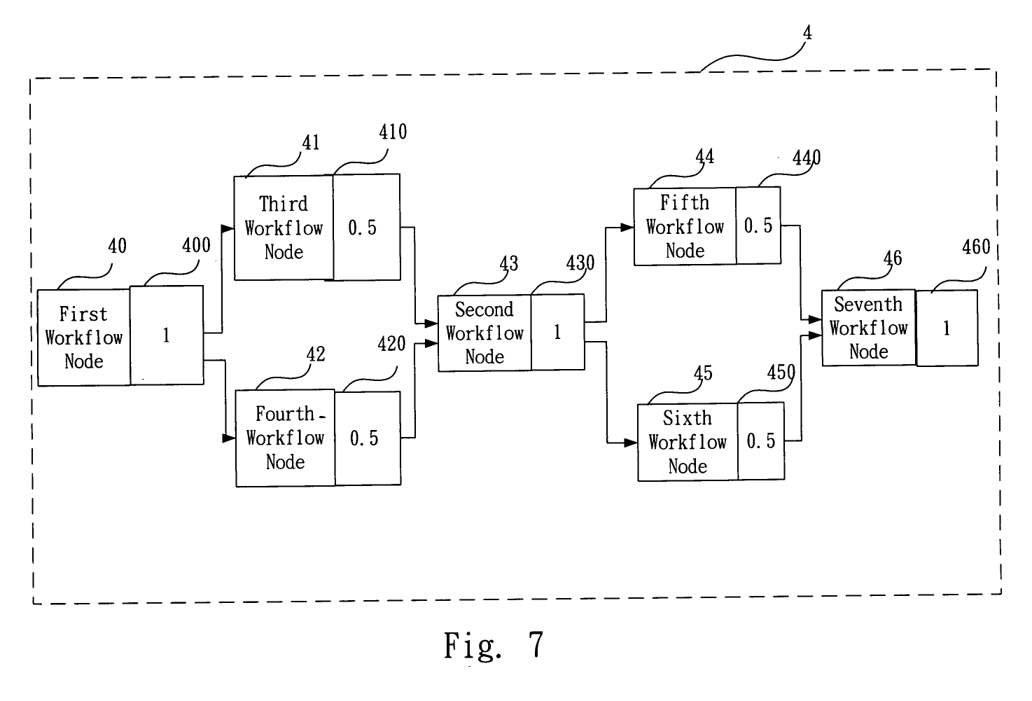

As shown in FIG. 7, a workflow 4 comprises a first workflow node 40, a second workflow node 43, a third workflow node 41, a fourth workflow node fifth workflow node 44, a sixth workflow node 45 and a seventh workflow node 46. Firstly, a fist weight factor 400 is set to be 1, a second weight factor 430 is calculated to be 1, a third weight factor 410 is 0.5, a fourth weight factor 420 is 0.5, a fifth weight factor 440 is 0.5, a sixth weight factor 450 is 0.5 and a seventh weight factor 460 is 1 when the workflow 4 is verified by the present invention as shown in FIG. 7.

The first weight factor 400 is verified to equal a sum of the third weight factor 410 and the fourth weight factor 420 (The sum of the weight factors of the upper level must equal the sum of the weight factors of the lower level). The sum of the third weight factor 410 and the fourth weight factor 420 is verified to equal the second weight factor 430. The second weight factor 430 is verified to equal a sum of the fifth weight factor 440 and the sixth weight factor 450. The sum of the fifth weight factor 440 and the sixth weight factor 450 is verified to equal the seventh weight factor 460. The sum of the third weight factor 410 and the fourth weight factor 420 is verified to equal the first weight factor 400 (The sum of the weight factors of the lower level must equal the sum of the weight factors of the upper level). Therefore, lastly, the first weight factor 400, the second weight factor 430, the third weight factor 410, the fourth weight factor 420, the fourth weight factor 420, the fifth weight factor 440, the sixth weight factor 450 and the seventh weight factor 460 are compared. The seventh weight factor 460 of the seventh workflow node 46 is verified to equal the first weight factor 400 of the first workflow node 50. In another word, the weight factor of the end workflow node (Seventh weight factor 460) must equal the weight factor of the initial workflow node (The first weight factor 400) in order to verify the workflow 4. In the embodiment, the first workflow node 40 is set to be the initial workflow node. The third workflow node 41, the fourth workflow node 42, the second workflow node 43, the fifth workflow node 44 and the sixth workflow node 45 are set to be middle workflow nodes. The seventh workflow node 46 is set to be an end workflow node.

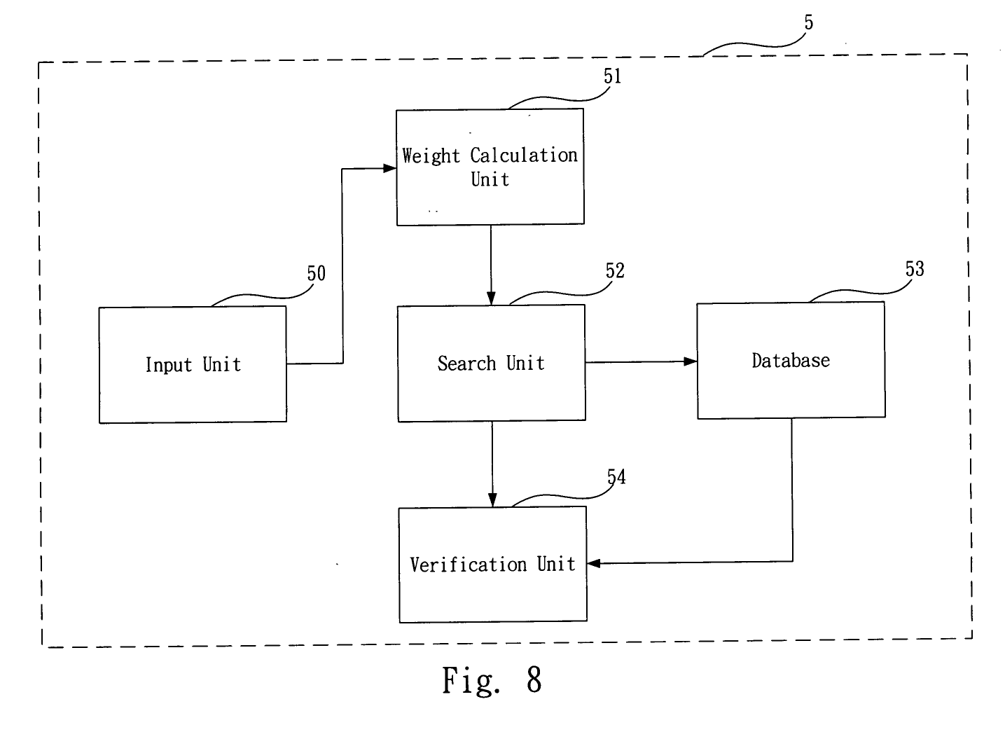

Referring to FIG. 8, a block diagram illustrates a workflow verification system according to a preferred embodiment of the present invention. The workflow verification system 5 comprises an input unit 50, a weight calculation unit 51, a search unit 52, a database 53 and a verification unit 54. The input unit 50 is used to provide a workflow inputted by a workflow planner. For example of the workflow as shown in FIG. 4, the workflow comprises the first workflow node, the plurality of workflow nodes and the second workflow node. A relationship between the first workflow node and the plurality of workflow nodes: the first workflow node is the upper level for the plurality of workflow nodes and the plurality of workflow nodes are the lower level for the first workflow node. A relationship between the second workflow node and the plurality of workflow nodes: the plurality of workflow nodes are the upper level for the second workflow node and the second workflow node is the lower level for the plurality of workflow node.

The weight factor of each workflow node is generated by the weight calculation unit 51 based on the planned workflow after the workflow planner completed to design and plan the workflow. For example of FIG. 4, the weight factor of the first workflow node, the weight factors of the plurality of workflow nodes and the weight factor of the second workflow node are automatically generated. The first weight factor of the first workflow node is the sum of the weight factors of the plurality of workflow nodes. The second weight factor of the second workflow node is the sum of the weight factors of the plurality of workflow nodes.

The weight factor of each workflow node is recorded by the database 53. The weight factor of the first workflow node, the weight factors of the plurality of workflow nodes and the weight factor of the second workflow node are compared by the verification unit 54. The second weight factor of the second workflow node is verified to equal the first weight factor of the first workflow node in order to generate a verification outcome to be a successful message or a failure message that confirms validity and accuracy for the workflow.

A program module is composed of the weight calculation unit 51, the search unit 52, and the verification unit 54 and codes in the program module are implemented by a processor to achieve the goal of the mentioned above. Furthermore, the workflow having the parallel routing is connected via Internet or any transmission way.

To conclude the workflow verification system and the method of the present invention, the weight factors of the workflow nodes of the upper level are verified to equal the weight factors of the workflow nodes of the lower level, or the weight factors of the workflow nodes of the lower level are verified to equal the weight factors of the workflow nodes of the upper level, and the weight factors of the end workflow nodes are verified to equal the weight factors of the initial workflow nodes by calculating the weight factor to provide the workflow planner for verifying the established workflow that then avoids to implement the error workflow caused by the careless mistake in the future.

Although the features and advantages of the embodiments according to the preferred invention are disclosed, it is not limited to the embodiments described above, but encompasses any and all modifications and changes within the spirit and scope of the following claims.

What is claimed is:

1. A workflow verification method, applied for verifying a workflow having a parallel routing, the workflow comprising a first workflow node, a second workflow node, and a plurality of workflow nodes between said first workflow node and said second workflow node, the method comprising the following steps:
setting a weight factor of said first workflow node;
calculating said plurality of workflow nodes based on said weight factor of said first workflow node, wherein said weight factor of said first workflow node equals a sum of weight factors of workflow nodes of a lower level which is connected to said first workflow node, said weight factor of said second workflow node equals a sum of weight factors of workflow nodes of an upper level which is connected to said second workflow node, said workflow nodes of said lower level and said workflow nodes of said upper level are parts of said plurality of workflow nodes;
comparing with weight factors corresponded by said first workflow node, said plurality of workflow nodes, and said second workflow node; and
verifying whether said weight factor of said second workflow node equals said weight factor of said first workflow node.

2. The method of claim 1, wherein said first workflow node and said plurality of workflow nodes are said upper level and said lower level respectively and said plurality of workflow nodes and said second workflow node are said upper level and said lower level, further comprises the following step:
verifying whether said weight factor of said second workflow node is a sum of said weight factors of said plurality of workflow nodes of said upper level.

3. The method of claim 2, further comprising the following step:
verifying whether said weight factor of said first workflow node is a sum of said weight factors of said plurality of workflow nodes of said lower level.

4. The method of claim 1, further comprising the following step:
generating a verification outcome to be a successful message if said weight factor of said second workflow node being verified to equal said weight factor of said first workflow node; and
generating a verification outcome to be a failure message if said weight factor of said second workflow node being verified to not equal said weight factor of said first workflow node.

5. A workflow verification system, applied for verifying a workflow having a parallel routing, said workflow comprising a first workflow node, a second workflow node, and a plurality of workflow nodes between said first workflow node and said second workflow node, said system comprising:
a weight calculation unit for generating a weight factor of said first workflow node, weight factors of said plurality of workflow nodes, and a weight factor of said second workflow node, wherein said weight factor of said first workflow node is a sum of said weight factors of said plurality of workflow nodes, said weight factor of said second workflow node is a sum of said weight factors of said plurality of workflow nodes; and
a verification unit for comparing with said weight factor of said first workflow node, said weight factors of said plurality of workflow nodes, and said weight factor of said second workflow node in order to verify whether said weight factor of said second workflow node equals said weight factor of said first workflow node.

6. The workflow verification system of claim 5, wherein said system further comprises an input unit for providing said workflow.

7. The workflow verification system of claim 5, wherein said first workflow node and said plurality of workflow nodes include a relationship between an upper level and a lower level and said plurality of workflow nodes and said second workflow node include a relationship between an upper level and a lower level.

8. The workflow verification system of claim 7, wherein said verification unit verifies whether said weight factor of said first workflow node equals said sum of said plurality of workflow nodes of said lower level and verifies whether said weight factor of said second workflow node equals said sum of said plurality of workflow nodes of said upper level.

9. The workflow verification system of claim 5, wherein said verification unit is to generate a verification outcome.

10. The workflow verification system of claim 9, wherein said verification outcome is a successful message.

11. The workflow verification system of claim 9, wherein said verification outcome is a failure message.

12. A workflow verification method, applied for verifying a workflow having a parallel routing, said workflow comprising an initial workflow node, an end workflow node, and a plurality of middle workflow nodes between said initial workflow node and said end workflow node, wherein said initial workflow node, said end workflow node, and said plurality of middle workflow nodes are formed a level connection, and after finishing verification works corresponded by said initial workflow node and said plurality of middle workflow nodes, follow-up verification works are transmitted to workflow nodes of a lower level, said end workflow node and said plurality of middle workflow nodes are continually verified after workflow node of an upper level is verified, said method comprises the following steps:
setting a weight factor of said initial workflow node;
calculating weight factors of said plurality of middle workflow nodes and a weight factor of said end workflow node, wherein said weight factor of said initial workflow node equals a sum of weight factors of workflow nodes of a lower level which is connected with said initial workflow node, weight factors of said plurality of middle workflow nodes equal a sum of weight factors of workflow nodes of a lower level which is connected with said plurality of middle workflow nodes, and a weight factor of said end workflow node equals a sum of weight factors of workflow nodes of an upper level which is connected with said end workflow node; and
verifying whether said weight factor of said end workflow node equals said weight factor of said initial workflow node.

13. The workflow verification method of claim 12, wherein said calculating said weight factors of said plurality of middle workflow nodes and said weight factor of said end workflow node further comprises:
allocating said weight factor of said initial workflow node equally to workflow nodes of said lower level under said initial workflow node; and
allocating said weight factors of said plurality of middle workflow nodes equally to workflow nodes of said lower level under said plurality of middle workflow nodes.

14. The workflow verification method of claim 12, wherein said method further comprises:
generating a verification outcome to be a successful message if said weight factor of said end workflow node is verified to equal said weight factor of said initial workflow node; and
generating said verification outcome to be a failure message if said weight factor of said end workflow node is verified to not equal said weight factor of said initial workflow node.

15. The workflow verification method of claim 12, wherein said method further comprises verifying whether a weight factor of a workflow node of said upper level equals a weight factor of a workflow node of said lower level.
